(19) United States
(12) Patent Application Publication
(10) Pub. No.: US 2011/0314917 A1
(43) Pub. Date: Dec. 29, 2011

(54) METHOD AND DEVICE FOR LOW FREQUENCY VIBRATION EXCITATION USING ULTRASONIC WAVE

(76) Inventors: Jin-Ho PARK, Daejeon (KR); Doo-Byung YOON, Daejeon (KR); Young-Chul CHOI, Daejeon (KR); Sung Hwan SHIN, Daejeon (KR)

(21) Appl. No.: 12/838,935

(22) Filed: Jul. 19, 2010

Related U.S. Application Data
(63) Continuation of application No. 12/825,961, filed on Jun. 29, 2010.

(51) Int. Cl. G01N 29/12

(52) U.S. Cl. 73/622

(57) ABSTRACT

Provided is a method and device for low frequency vibration excitation, which may generate a low frequency using a plurality of ultrasonic generators for high frequency. The method generates ultrasonic waves using a plurality of ultrasonic generators attached to a target structure to induce a beat phenomenon, and extract a frequency lower than a frequency of each of the plurality of the ultrasonic generators to measure a property of the target structure, and thereby may be freely applied to a target structure, regardless of a shape of the target structure such as a plate, a curved pipe, and the like, using a relatively small-sized ultrasonic sensor for high frequency, and may excite a specific frequency of an acceleration range, so that the ultrasonic excitation method may be applicable in a relatively poor Signal-to-Noise Ratio (SNR) range.

### CROSS-REFERENCE TO RELATED APPLICATION

The present application is a continuation of U.S. application Ser. No. 12/825,961, filed Jun. 29, 2010, which is hereby incorporated by reference in its entirety.

### BACKGROUND

### Field of the Invention

Exemplary embodiments of the present invention relate to a method and device for low frequency vibration excitation using ultrasonic waves, and more particularly, to a method and device for low frequency vibration excitation using ultrasonic waves, which may generate a low frequency range using a plurality of ultrasonic sensors for high frequency, may be freely applied to a target structure, regardless of a shape of the target structure such as a plate, a curved pipe, and the like, using a relatively small-sized ultrasonic sensor for high frequency, and may excite a specific frequency of an acceleration range, so that the ultrasonic excitation method may be applicable in a relatively poor Signal-to-Noise Ratio (SNR) range.

### DISCUSSION OF THE BACKGROUND

FIG. 1 is a graph illustrating a dispersive curve on a plate, according to a related art. As illustrated in FIG. 1, as a high frequency is approached, many modes are complexly overlapped. However, since only an asymmetric a0 wave exists in a low frequency range, a variety of information regarding prediction of a thickness of a pipe, defect detection, prediction of properties, and the like may be obtained through the low frequency range.

For example, referring to “Inspection device, method for thickness and material properties of structure and monitoring method for thickness thinning of the same” disclosed in Korean Patent No. 10-817617 of this applicant, low frequency vibration waves may be excited to a target structure, and a group speed may be calculated based on a delay time, using a pair of vibration wave measurement units mounted on an outer surface of the target structure to be separated from each other by a predetermined distance, so that a thickness of the target structure between the pair of vibration wave measurement units may be predicted The pair of vibration wave measurement units are mounted along an advancing direction of the low frequency vibration waves, so that a thickness of the target structure between the pair of vibration wave measurement units may be predicted.

Also, even though the target structure is a plate, a pipe, and other structures having various shapes, the above described method may be used to predict the thickness or properties of the target structure. In particular, the above described method may be applied to a pipe used in a turbine generator of a nuclear power plant, thereby predicting pipe thinning on a structure using thickness information of the pipe.

In general, an ultrasonic sensor may be used to excite the vibration wave, however, the ultrasonic sensor of a low frequency may disadvantageously be relatively large sized in terms of its structural characteristics. Accordingly, it is difficult to apply the above described method to a small-sized structure such as a plate, a pipe, and the like.

Therefore, there is a desire for a method of exciting a low frequency using a relatively small-sized ultrasonic sensor for high frequency.

### BRIEF SUMMARY

An aspect of the present invention provides a method and device for low frequency vibration excitation using ultrasonic waves, which may generate a low frequency using a plurality of ultrasonic sensors for high frequency

Another aspect of the present invention provides a method and device for low frequency vibration excitation using ultrasonic waves, which may be freely applied to a target structure, regardless of a shape of the target structure such as a plate, a curved pipe, and the like, using a relatively small-sized ultrasonic sensor for high frequency.

Still another aspect of the present invention provides a method and device for low frequency vibration excitation using ultrasonic waves, which may excite a specific frequency of an acceleration range to thereby be applied even to a poor Signal-to-Noise Ratio (SNR) range.

According to an aspect of the present invention, there is provided a method for low frequency vibration excitation which generates ultrasonic waves using a plurality of ultrasonic generators attached to a target structure to induce a beat phenomenon, and extracts a frequency lower than a frequency of each of the plurality of the ultrasonic generators to measure a property of the target structure.

According to another aspect of the present invention, there is provided a method for low frequency vibration excitation which induces a beat phenomenon using two ultrasonic generators, and extracts a difference in frequencies of the ultrasonic generator from an acceleration range to measure a property of a target structure.

According to still another aspect of the present invention, there is provided a device for low frequency vibration excitation, the device including: a target structure; a first ultrasonic generator to excite ultrasonic waves of a first frequency on the target structure; and a second ultrasonic generator to excite ultrasonic waves of a second frequency on the target structure, the second frequency being similar to the first frequency, wherein a property of the target structure is measured by extracting a difference between the first frequency and the second frequency using a beat phenomenon.

In this instance, as the target structure, any one of a plate, a pipe, and other various shaped structures may be used, and the measured property may be diversely provided.

Thus, it is possible to generate a low frequency using a plurality of relatively small-sized ultrasonic sensors for a high frequency, so that the ultrasonic excitation method and device may be freely applied to a target structure, regardless of a shape of a target structure such as a plate, a pipe, and the like.

Also, it is possible to excite a specific frequency of an acceleration range, so that the ultrasonic excitation method and device may be applied to a poor SNR range.

It is to be understood that both the foregoing general description and the following detailed description are exemplary and explanatory and are intended to provide further explanation of the invention as claimed.

### EFFECT

As described above, according to an embodiment, there is provided a method and device for low frequency vibration excitation, which may excite a low frequency using a plurality of ultrasonic sensors for high frequency.

Also, according to an embodiment, there is provided a method and device for low frequency vibration excitation, which may be freely applied to a target structure, regardless of a shape of the target structure such as a plate, a curved pipe, and the like, using a relatively small-sized ultrasonic sensor for high frequency.

Also, according to an embodiment, there is provided a method and device for low frequency vibration excitation, which may excite a specific frequency of an acceleration range, and thus the ultrasonic excitation method and device may be applied to a poor Signal-to-Noise Ratio (SNR) range.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a graph illustrating a dispersive curve on a plate;

FIG. 2 is a schematic view illustrating an experimental device where a method for low frequency vibration excitation is performed according to an embodiment is applied to a plate;

FIG. 3 is a graph illustrating acceleration signals and ultrasonic signals in a measurement point of a plate;

FIG. 4 is a graph illustrating a spectrum of ultrasonic signals;

FIG. 5 is a graph illustrating a spectrum of acceleration signals;

FIG. 6 is a schematic view illustrating an experimental device where a method for low frequency vibration excitation is performed according to an embodiment is applied to a pipe;

FIG. 7 is a graph illustrating acceleration signals and ultrasonic signals in a measurement point of a pipe; and

FIG. 8 is a graph illustrating a spectrum of ultrasonic signals and acceleration signals.

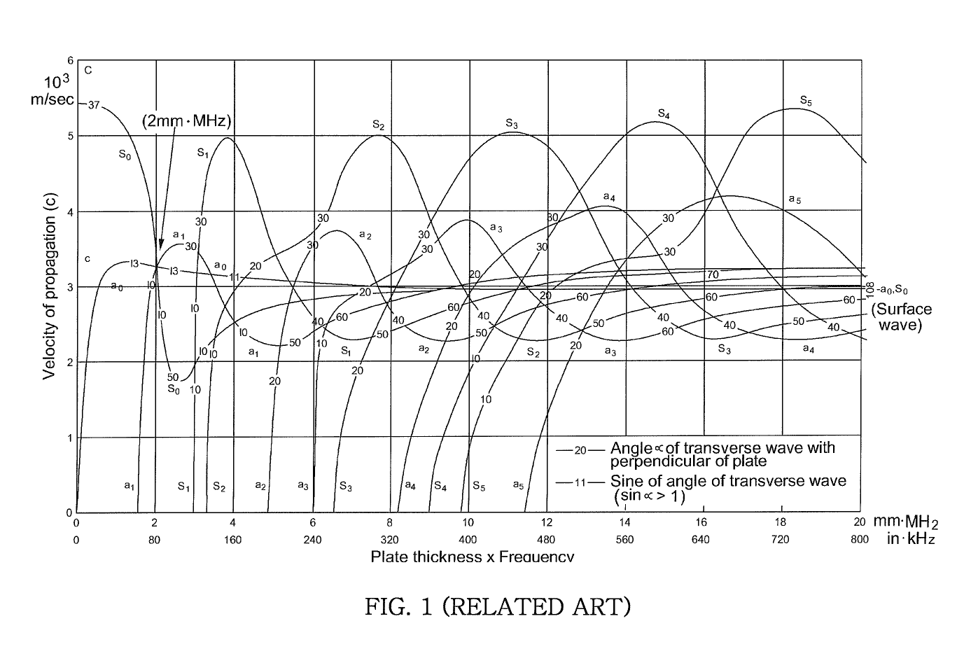

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

It may be well known that a beat phenomenon is generated when simultaneously generating two sine waves having adjacent frequencies. The beat phenomenon may be generated due to types of interference caused by two waves. In this instance, a wave generated by the beat phenomenon may advance to have a frequency having an intermediate value of two previously generated wave frequencies, and an amplitude of the wave generated by the beat phenomenon may be changed by a relatively slower new cycle.

More specifically, the two sine waves may be defined in the following Equations 1 and 2.

y₁(t)=A sin(k₁·x−ω₁·t) Equation 1

, and

y₂(t)=A sin(k₂·x−ω₂·t) Equation 2

When the two sine waves that are simultaneously generated are combined, Equation 3 below may be obtained.

$$\begin{matrix}y ( t ) = {y}_{1} ( t ) + {y}_{2} ( t ) \\ = 2 A cos [ \frac{{k}_{1} - {k}_{2}}{2} \cdot x - \frac{{ω}_{1} - {ω}_{2}}{2} \cdot t ] \cdot \\ sin [ \frac{{k}_{1} + {k}_{2}}{2} \cdot x - \frac{{ω}_{1} - {ω}_{2}}{2} \cdot t ] ,\end{matrix} \qquad Equation 3$$

where k represents a wave number, w represents a frequency, and t represents a time.

In Equation 3, a center frequency may be an average of two frequencies of the two sine waves when the two sine waves are combined, however, an entire shape of the waves may be vibrated by a half cycle of a difference of the two frequencies. Specifically, when appropriately adjusting the frequencies of the two sine waves, a relatively low frequency may be excited.

Thus, an ultrasonic sensor may generate a high frequency wave of several hundreds of kHz, however, a sine wave of several kHz of an acceleration range may be generated when appropriately adjusting a frequency using two ultrasonic sensors.

To verify the above described method, the following experiment was carried out.

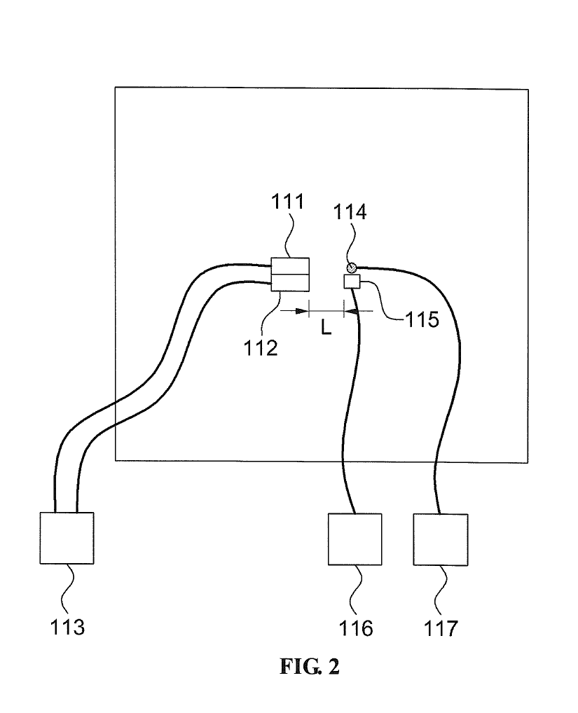

FIG. 2 is a schematic view illustrating an experimental device where a method for low frequency vibration excitation is performed according to an embodiment is applied to a plate.

To verify that a low frequency is excited using the beat phenomenon of an ultrasonic generator of exciting two high frequencies in the experiment, two ultrasonic generators 110 and 120 of a high frequency may be mounted on a plate 10 to excite two sine waves of 400 kHz and 430 kHz, respectively. The ultrasonic generators 110 and 120 may be respectively connected to a function generator 130. In a measurement point, an ultrasonic sensor 150 and an accelerometer 140 may be mounted in the same position to acquire signals. The ultrasonic sensor 150 and the accelerometer 140 may be respectively connected to data acquisition modules 160 and 170 for acquiring signals. The experiment was carried out based on 0.1 m of a distance (L) among the ultrasonic generators 110 and 120, the ultrasonic sensor 150, and the accelerometer 1450.

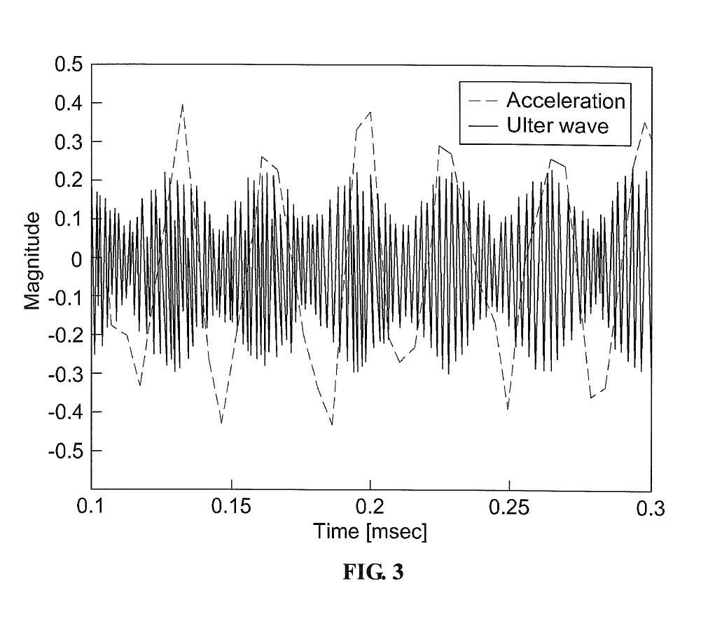

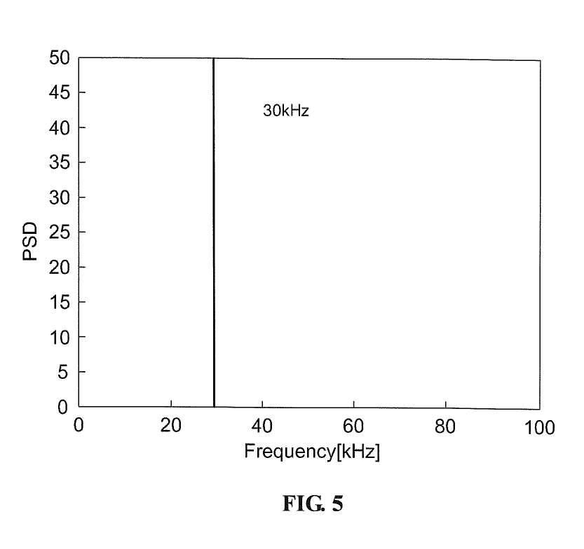

The result of the above described experiment is illustrated in FIGS. 3 and 5.

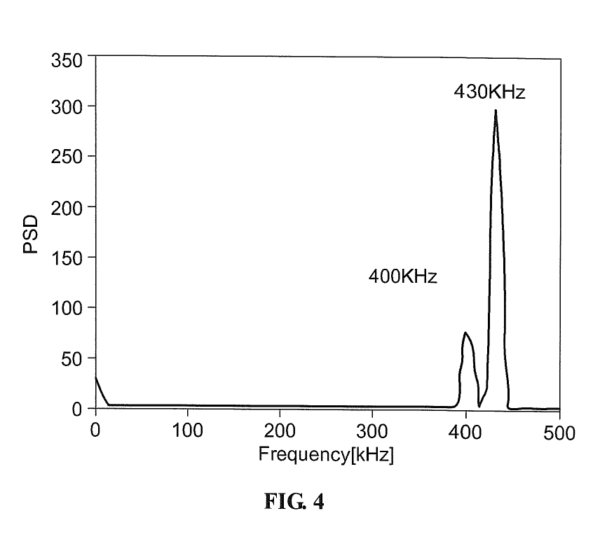

FIG. 3 is a graph illustrating acceleration signals and ultrasonic signals in a measurement point of a plate, FIG. 4 is a graph illustrating a spectrum of ultrasonic signals, and FIG. 5 is a graph illustrating a spectrum of acceleration signals.

As illustrated in FIG. 3, generation of the beat phenomenon may be verified by two similar high frequency signals of 400 kHz and 430 kHz. Referring to Equation 3, a center frequency of 415 kHz may be vibrated by a half cycle of a difference in magnitudes of the two high frequencies.

Ultrasonic waves may generate two high frequencies of 400 kHz and 430 kHz, as illustrated in FIG. 4, however, only 30 kHz corresponding to a difference between the two high frequencies may be detected as signals of an accelerometer 140, as illustrated in FIG. 5. Specifically, through this experiment, the beat phenomenon may be generated using the ultrasonic sensor for exciting two high frequencies on a plate to generate low frequency signals in an acceleration range.

Next, the following experiment regarding whether the ultrasonic excitation method according to an embodiment is applied to a pipe was carried out.

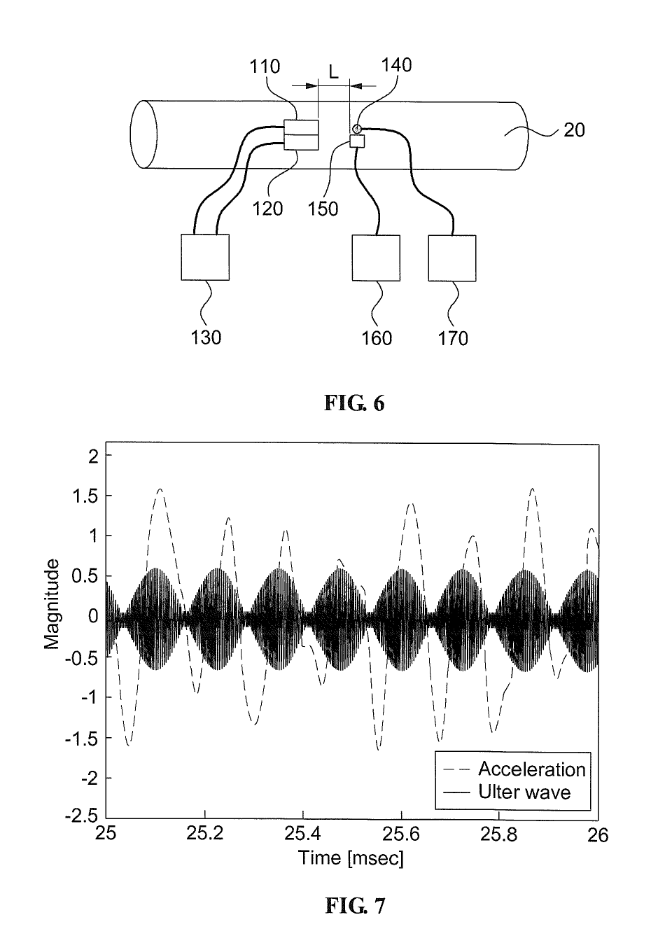

FIG. 6 is a schematic view illustrating an experimental device where a method for low frequency vibration excitation is performed according to an embodiment is applied to a pipe.

This experiment was carried out in the same manner as that applied to the plate, and the experimental device of FIG. 6 may be the same as that of FIG. 2, and thus further descriptions thereof will be omitted. In the experiment applied to the pipe, an excitation frequency of each ultrasonic sensor was 300 kHz and 308 kHz.

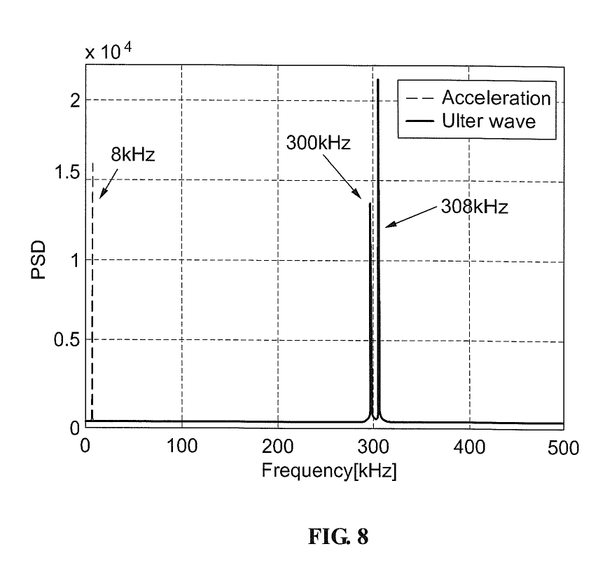

Results of the experiment applied to the pipe are illustrated in FIGS. 7 and 8.

FIG. 7 is a graph illustrating acceleration signals and ultrasonic signals in a measurement point of a pipe; and FIG. 8 is a graph illustrating a spectrum of ultrasonic signals and acceleration signals.

As illustrated in FIG. 7, generation of the beat phenomenon may be verified by two high frequencies of 300 kHz and 308 kHz. In FIG. 8, a line corresponding to two high frequencies of 300 kHz and 308 kHz may signify ultrasonic wave signals, and a line corresponding to 8 kHz may signify acceleration signals. Specifically, only 8 kHz of a difference of the two high frequencies 300 kHz and 308 kHz may be detected in the acceleration range. Consequently, similar to the above experiment with regard to the plate, low frequency signals may be generated in the acceleration range by the beat phenomenon when exciting the similar high frequencies. Also, using the ultrasonic excitation method according to an embodiment, a specific frequency of the acceleration range may be excited, and thus the ultrasonic excitation method may be applied to a poor SNR range.

Specifically, even without using the relatively large-sized ultrasonic sensor for exciting a low frequency, the low frequency may be excited using a relatively small-sized ultrasonic sensor, so that the ultrasonic excitation method may be applied to a plate, a pipe, and other shaped structures. Through the above described ultrasonic excitation method, properties such as a thickness of a target structure may be measured, and structural characteristics of the target structure may be measured.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for low frequency vibration excitation comprising:
generating ultrasonic waves using a plurality of ultrasonic generators attached to a target structure to induce a beat phenomenon, and
extracting a frequency lower than a frequency of each of the plurality of the ultrasonic generators to measure a property of the target structure.

2. The method of claim 1, wherein the target structure is one of a plate and a pipe.

3. The method of claim 1, wherein the property is a thickness of the target structure.

4. A device for low frequency vibration excitation, comprising:
a target structure;
a first ultrasonic generator to excite ultrasonic waves of a first frequency on the target structure; and
a second ultrasonic generator to excite ultrasonic waves of a second frequency on the target structure, the second frequency being similar to the first frequency,
wherein a property of the target structure is measured by extracting a difference between the first frequency and the second frequency using a beat phenomenon.

5. The device of claim 4, wherein the target structure is one of a plate and a pipe.

6. The device of claim 4, wherein the property is a thickness of the target structure.

7. A method for low frequency vibration excitation comprising:
inducing a beat phenomenon using two ultrasonic generators, and
extracting a difference in frequencies of the ultrasonic generator from an acceleration range to measure a property of a target structure.

8. The method of claim 7, wherein the target structure is one of a plate and a pipe.

9. The method of claim 7, wherein the property is a thickness of the target structure.
